(19) United States
(12) Patent Application Publication
(10) Pub. No.: US 2011/0029522 A1
(43) Pub. Date: Feb. 3, 2011

(54) Photo-image Discovery Device Database Management

(76) Inventors: Tushar Tyagi, Sunnyvale, CA (US); Dimitry Vaysburg, Livermore, CA (US); Prodyut Hazarika, Mountain View, CA (US)

Correspondence Address: LAW OFFICE OF GERALD MALISZEWSKI, P.O. BOX 270829, SAN DIEGO, CA, 92198-2829, US

(21) Appl. No.: 12/512,411

(22) Filed: Jul. 30, 2009

(51) Int. Cl. G06F 17/00

(52) U.S. Cl. 707/737; 707/E17.001

(57) ABSTRACT

A system and method are provided for managing a database in a photo-image discovery device. A photo-image discovery device acquires photo-images from a photo-capable device, and automatically classifies the acquired photo-images, without user intervention, in a database management directory. Then, the acquired photo-images are managed in a photo-image discovery device storage-in-transit memory using database management directory rules cross-referenced to classification. For example, the method may uplink photo-images to a network-connected site in response to their classification. Photo-image classification may be based upon photo-capable device type, photo-capable device ID, image creation data, image creation location, or file format.

### RELATED APPLICATIONS

This application is a Continuation-in-Part of a pending application entitled, LIGHT EMITTING DEVICE HISTORY LOG, invented by Dimitry Vaysburg, Ser. No. 12/468,468, filed May 19, 2009, attorney docket no. applied_{—}346;

which is a Continuation-in-Part of a pending application entitled, PHOTO MANAGEMENT USING EXPRESSION-BASED VOICE COMMANDS, invented by Gopi et al., Ser. No. 12/436,092, filed May 5, 2009, attorney docket no. applied_{—}343;

which is a Continuation-in-Part of a pending application entitled, SYSTEM AND METHOD FOR PHOTO-IMAGE LOCAL DISTRIBUTION, invented by Gopi et al., Ser. No. 12/436,086, filed May 5, 2009, attorney docket no. applied_{—}333;

which is a Continuation-in-Part of a pending application entitled, SYSTEM AND METHOD FOR PHOTO-IMAGE UPLINK CONFIRMATION, invented by Vaysburg et al., Ser. No. 12/432,625, filed Apr. 29, 2009, attorney docket no. applied_{—}345;

which is a Continuation-in-Part of a pending application entitled, SYSTEM AND METHOD FOR VIRTUAL KIOSK STORED PHOTO-IMAGE REPRODUCTION, invented by Vaysburg et al., Ser. No. 12/431,914, filed Apr. 29, 2009, attorney docket no. applied_{—}332;

which is a Continuation-in-Part of a pending application entitled, SYSTEM AND METHOD FOR PHOTO-IMAGE DISCOVERY AND STORAGE, invented by Vaysburg et al., Ser. No. 12/432,559, filed Apr. 29, 2009, attorney docket no. applied_{—}330. All these disclosures are incorporated herein by reference.

### BACKGROUND OF THE INVENTION

1. Field of the Invention

This invention generally relates to electronic image processing and, more particularly, to a system and method for the management of a photo-image discovery device with a storage-in-transit memory.

2. Description of the Related Art

Conventional technology permits a user to connect their camera, memory card, or cell phone to a personal computer (PC), open a software application in the PC, and upload images for local storage. Once the images are stored, the user may select images for local printing, organize folders, or create a CD. Further, the images may be uploaded to a network-connected storage site vendor, such as Costco. Once the images are uploaded, the user may select images for printing, and have the printed pictures prepared for pickup or delivery. Otherwise, the user can have the images archived.

Unfortunately, these operations are cumbersome and require extensive human interaction. Further, a minimal amount of technical acumen is required to perform these operations, and if the user is technophobic, the images may remain in the camera until they are lost, erased, or overwritten.

The management of data files stored on a camera or cell is also relegated to the user, as it is complicated for a device to automatically determine which images are to be retained in long-term memory, and which are to temporarily buffered in a storage-in-transit memory. For example, the user must determine which pictures to erase, which pictures to locally save, and which pictures to send to remote storage. Further, there may be decisions involving the remote storage site, especially if the user is concerned with variables such as cost, remote storage capacity, and uplink bandwidth. However, as noted above, many users find these tasks cumbersome. The brute force fix to this problem is to save everything, in the belief that the user will edit, stored data at a future time. However, there is a cost associated with data storage, whether it is done remotely or locally, and the problem is exasperated by the continued growth of device memories, creating more data for the user to manage.

It would be advantageous if image data files could be automatically managed, without, user intervening.

### SUMMARY OF THE INVENTION

A photo discovery system and method are disclosed herein that are capable of acquiring images from a variety of different sources, such as a digital camera, camcorder, 3G phone, cell phone, or personal computer (PC), and upload them into an Internet-connected storage/processing service. Once stored, the same photo discovery device can be used to print, archive, or otherwise manage the images as a virtual kiosk, without the use of a personal computer (PC). The photo-image files are dynamically managed in a manner that simplifies and optimizes storage based upon, factors such as an in-transit buffer data retention policy.

Accordingly, a method is provided for managing a database in a photo-image discovery device. In this method a photo-image discovery device acquires photo-images from a photo-capable device, and automatically classifies the acquired photo-images, without user intervention, in a database management directory. Then, the acquired photo-images are managed in a photo-image discovery device storage-in-transit memory using database management directory rules cross-referenced to classification. For example, the method may uplink photo-images to a network-connected site in response to their classification. Photo-image classification may be based upon photo-capable device type, photo-capable device ID, image creation data, image creation location, or file format.

Further, the acquired photo-images may be uplinked in response to a condition such as the current uplink conditions, available uplinks, current network-connected storage site conditions, network-connected storage site processing time backlog, network-connected storage site processing cost changes, network-connected storage site memory capacity, network-connected storage site memory capacity changes, uplink bandwidth, photo-image media type, network-connected, storage site account balance, or a photo-image uplink priority scheme.

Additional details of the above-described method, and a photo-image discovery device with a system for managing a database, are provided below.

### BRIEF DESCRIPTION OF THE DRAWINGS

FIG. 1 is a schematic block diagram of a system for managing a database in a photo-image discovery device.

FIG. 2 is a diagram depicting a lookup table (LUT) cross-referencing classification to rules.

FIG. 3 is a diagram depicting an exemplary removable media memory storage-in-transit file structure.

FIG. 4 is a flowchart illustrating a method for a system using a microprocessor executing software instructions stored in a computer-readable medium to manage a database in a photo-image discovery device.

### DETAILED DESCRIPTION

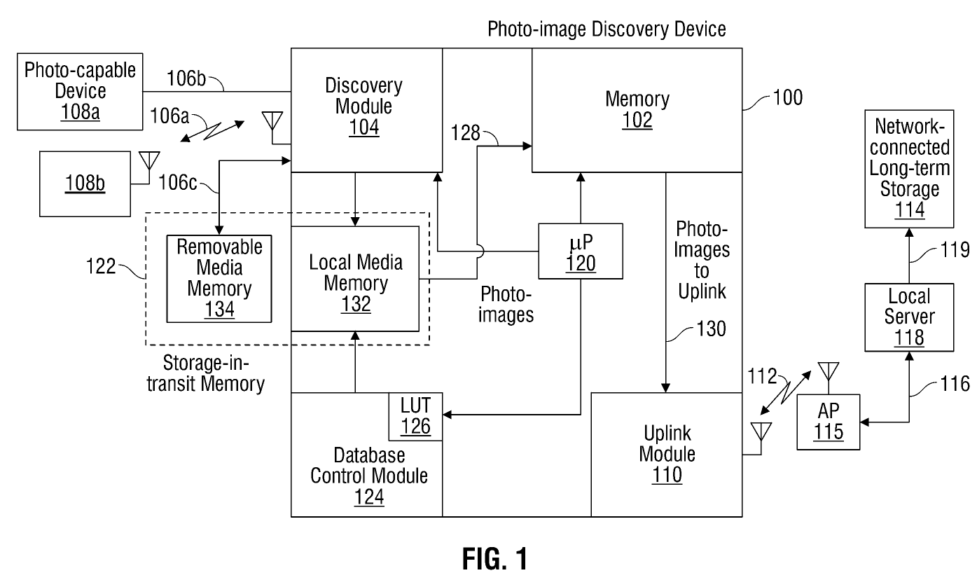

FIG. 1 is a schematic block diagram of a system for managing a database in a photo-image discovery device. As explained in more detail below, the system is comprised of hardware components. Some aspects of the system may be enabled using state machine and combinational logic modules. However, the system may include a microprocessor executing software instructions stored in a computer-readable medium. The photo-image discovery device 100 comprises a permanent memory 102 and a discovery module 104 having a scanning interface on line 108 for detecting photo-capable devices. In one aspect, the discovery module scanning interface concurrently scans wireless and hardwired connector interfaces. The wireless interface is represented by reference designator 106a and the hardwire connector interface by reference designator 106b. For simplicity, only a single wireless and single hardwired interface are shown. However, it should be understood that multiple such interfaces may be required for different protocols, frequencies, and connector types.

Some examples of the wireless interface 108a include Bluetooth, wireless USB, and IEEE 802.11 (WiFi) interfaces. However, the device 100 is not limited to just these examples. Some examples of hardwire connector interface 106b include Universal Serial Bus (USB) and SD memory card interfaces. Some examples of photo-image file types include JPEG, GIF, EXIF, native format, BMP, CR2, RAW, and MPEG. Again, the system, is not limited to just these exemplary file types and interfaces.

The discovery module 104 determines if detected photo-capable devices 108 have stored electronically formatted photo-images, and if so, acquires the photo-images into the memory 102. Some examples of photo-capable devices include a cellular telephone, 3G cell phone, a personal computer (PC), controlled automation device, digital video disk (DVD) device, camera-enabled wireless device, video-enabled wireless device, television, digital video recorder (DVR), secure digital (SD) memory card, digital camera, and game console. Some examples of a controlled automation device include home camera security system and a remotely programmable DVR. In one aspect, the discovery module 104 acquires photo-images from only preconfigured photo-capable devices 108. That is, the discovery module 104 will only acquire photo-images from a limited group of devices with which it has been given permission to act.

An uplink or network module 110 has a network interface on line 112. The uplink module 110 automatically uploads the photo-images in the memory 102 to a network-connected long-term storage site 114. Although only a single storage site is shown for simplicity, it should be understood that the photo-image discovery device is able to communicate with any number of storage sites. The photo-image discovery device may send the same photo-images to more than one storage site. As used herein, a storage site may be a commercial site for printing or archiving photo-images, a site for sharing or publishing photo-images, such as YouTube, or even a local storage site. As another example, a user may be able to monitor their home security system via images sent to a “public” site such as YouTube. As another example, the discovery device may acquire a movie, from a device such as a PC, and store the movie in a local memory site. As another example, the discovery device may transfer photo-images acquired from one photo-capable device to a different photo-capable device. In this manner, the photos on one SD card in a first camera may be loaded into the SD card residing in a second camera.

In one aspect, the uplink module 110 uploads photo-images via a WiFi interface to a network-connected server 114. As shown, a WiFi access point (AP) 115 wirelessly receives information from the photo-image discovery device, transfers the information via a landline 116 to a local server 118, which then uses an Internet protocol to transfer the information to storage server 114 via line 119. However, it would be possible to upload photo-images using other nodes or other protocols to reach the storage site.

As noted above, the system may further comprise a processor or microprocessor (μP) 120. If so, the discovery module may be a software application stored in permanent memory with instructions executed by processor 120. For simplicity, the discovery module is shown as separate from the memory 102 and microprocessor 120. A storage-in-transit memory 122 stores acquired photo images. A database control module 124 automatically classifies acquired photo-images in the storage-in-transmit memory 122 using database management directory rules cross-referenced to classification. Again, the database control module may be a software application stored in memory 102 comprised of instructions executed by processor 120. For simplicity, the database control module 124 is depicted as separate from the memory 102 and processor 120.

The database control module 124 classifies photo-images based upon photo-image source information. The source information may be the photo-capable device type. For example, classification may be based upon camera type, or alternately, the classification may distinguish between, cameras and cell phones. Classification may also be based upon photo-capable device ID (e.g., a camera associated with a particular user). Otherwise, classification may be based upon image creation data, image creation, location, or file format.

In one aspect, the database control module 124 automatically uplinks photo-images to the network-connected site 114 in response to their classification. Typically, the photo-images would be transported from the storage-in-transit memory 122 to the permanent memory 102 via line 128, and then to the uplink module via line 130. The uplinking may be responsive to a condition such as current uplink conditions (e.g., connection quality) or available uplinks (e.g., an Internet access tunnel to a URL). The uplinking may also be responsive to current network-connected storage site conditions, network-connected storage site processing time backlog, network-connected storage site processing cost changes, network-connected storage site memory capacity, network-connected, storage site memory capacity changes, uplink bandwidth. photo-image media type, network-connected storage site account balance, or a photo-image uplink priority scheme. The priority scheme may be based upon a minimum bandwidth guarantee or the best effort of a shared connection.

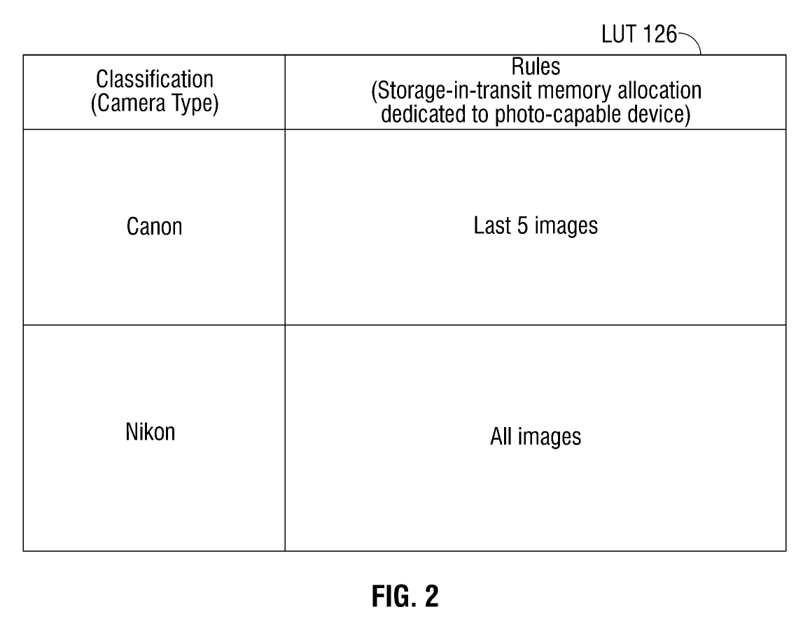

FIG. 2 is a diagram depicting a lookup table (LUT) cross-referencing classification to rules. The LUT 126 may be embedded with the database control module for example. Note; a user may be required to perform a one-time initialization process that cross-references rules to image classifications. Once a photo-image is classified, the database control module can manages the photo-image by applying a cross-referenced rule. In this example photo-images are classified by camera type. There are two possible categories under the classification of camera type, one for a Canon camera and one for a Nikon. In this example a single rule is applied to the classification—storage-in-transmit memory allocation dedicated to a particular photo-capable device. For the Canon camera, only the 5 latest images are saved in the in-transit memory. For the Nikon, all images are saved.

There are an indefinitely large number of possible rules. Some examples of rules follow; photo-image media type (e.g., JPEG2, TIFF, XIFF, etc.) or meta-data information. Meta-data information may include the content label, time (data date), photo-image format, and corresponding data. In the case of video, corresponding data may be a synchronous audio file. Thus, a meta-data information rule may save the image creation date. Another rule is acquisition limits. For example, the quantity of information that may be downloaded into the storage-in-transit memory may be based upon memory allocation. Alternately, photo-images may be acquired into the storage-in-transit memory at a rate response to uplink storage capacity and uplink storage site bandwidth.

Rules may also be based upon the current storage-in-transmit memory status (e.g., the amount of information already residing in the storage-in-transit), or permitted photo-capable devices (e.g., no cell phone photos allowed).

A rule for storage-in-transmit memory allocation dedicated to an uplink network-connected storage site may determine that, only half the in-transit memory may be used for photo-images destined for a Walmart site. A photo-image storage-in-transmit memory preservation time rule may determine that photo-images are not retained in the in-transit memory for more than a week. A folder designation rule may divide the in-transit memory into folders, and photo-image discovery device power level rule may determine that no images are loaded into the in-transit memory when the device power level dips below 50%.

Returning to FIG. 1, the system may further comprise a local media memory 132 and a removable media memory 134 connected to the discovery module acquisition interface via line 106c. The database control module 124 distributes photo-images in a storage-in-transit memory structure 122 consisting of the local media memory 132, the removable media memory 134, or a combination of local and removable media memories.

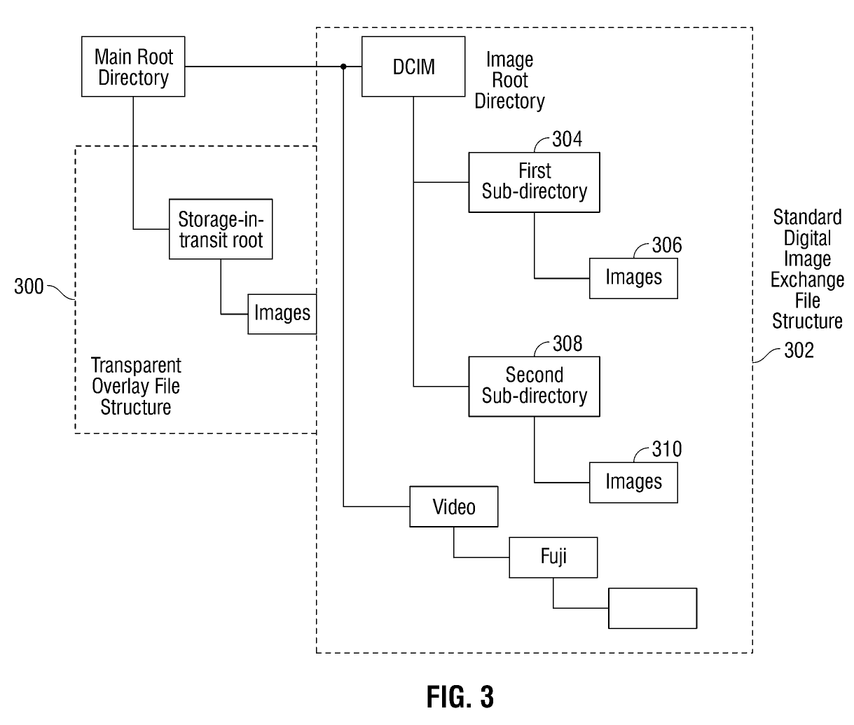

FIG. 3 is a diagram depicting an exemplary removable media memory storage-in-transit file structure. The standard media format for pictures is a design rule for camera file system (DCF) directory. Conventionally, all the photo-images reside under a local (DCIM) directory and the camera creating such a directory may have a scratch pad (not residing on the removable medium) where all files numbers are recorded, as well as their special attributes, such as size or tags, so camera processor knows the last JPEG file number used and how much room, is left in the memory. Video is kept in a separate directory.

The storage-in-transit file structure is completely outside of the conventional camera domain. The storage-in-transit root file folder is few hundred bytes-much less that memory required for a single picture.

In one aspect, the discovery module accepts a removable media memory with photo-images organized in a standard digital image exchange file structure, as defined by JEITA CP-3461. The database control module distributes photo-images in a storage-in-transit memory structure by creating a transparent overlay file structure 300 in the removable media memory, in parallel with the standard digital image exchange file structure 302. The transparent overlay file structure 300 is invisible to a photo-capable device, once the removable media memory (e.g., an SD memory card) is inserted into a photo-capable device such as a camera. The database control module is capable of incorporating the removable media memory into the photo-image discovery device storage-in-transmit memory.

In one aspect as shown, the discovery module accepts photo-images 306 in a first sub-directory 304 of the standard digital image exchange file structure associated with, a first photo-capable device protocol (e.g., Nikon) and the database control module stores photo-images 310 in the removable media memory in a second sub-directory 308 of the standard digital image exchange file structure associated with a second photo-capable device protocol (e.g., Canon).

### Functional Description

The system depicted in FIGS. 1-3 permits disparate media (a combination of removable and stationary) to be managed as one mass media storage entity. Since removable media may disappear and reappear asynchronously, a “marker” may be created for each individual media associated with the database. Each new media can be marked as soon as it is connected to the photo-image discovery device. The information stored in the removable media is transparent to a digital camera or mass storage devices, and the creation and management of these folders is guided by the flexible policy that is also transparent to a user.

Incoming data is classified using criteria such as file source parameters, and the storage-in-transit buffer is managed on the basis of status (e.g., capacity thresholds), as well as destination parameters such as Internet link BW, latency, user folder limits, transfer success, storage price per MB, daily quota limits, etc. The storage-in-transit rules provide a method of disposition (purging) of various data file groups, such as duplicates, successfully uploaded files, files that were rejected (in n upload attempts or left in storage for k days). Further, statistics on all aforementioned events and actions can be maintained.

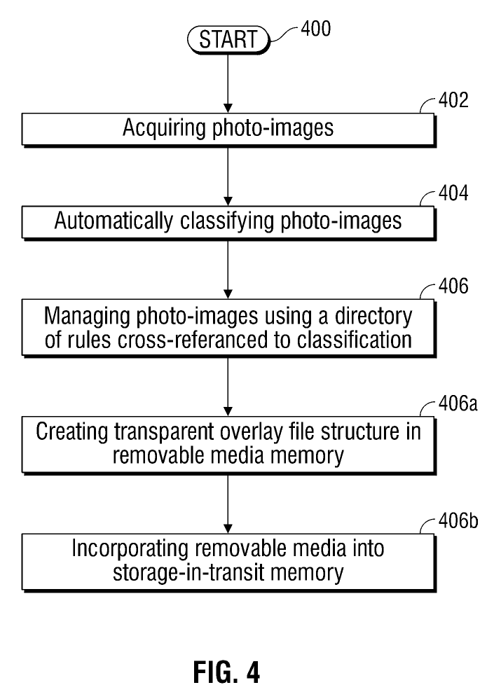

FIG. 4 is a flowchart illustrating a method for a system using a microprocessor executing software instructions stored in a computer-readable medium to manage a database in a photo-image discovery device. Although the method is depicted as a sequence of numbered steps for clarity, the numbering does not necessarily dictate the order of the steps. It should be understood that some of these steps may be skipped, performed in parallel, or performed without the requirement of maintaining a strict order of sequence. The method starts at Step 400.

In Step 402 a photo-image discovery device acquires photo-images from a photo-capable device. Step 404 automatically classifies the acquired photo-images, without user Intervention, in a database management directory. For example, photo-images may be classified based upon photo-image source information such as photo-capable device type, photo-capable device ID, image creation date, image creation location, or file format. Step 406 manages the acquired photo-images in a photo-image discovery device storage-in-transit memory using database management directory rules cross-referenced to classification.

In one aspect, managing the acquired photo-images in the storage-in-transit memory (Step 406) includes automatically uplinking photo-images to a network-connected site in response to their classification. In another aspect, Step 406 uplinks the photo-images in response to a condition such as current uplink conditions, available uplinks, current network-connected storage site conditions, network-connected storage site processing time backlog, network-connected storage site processing cost changes, network-connected storage site memory capacity, network-connected storage site memory capacity changes, uplink bandwidth, photo-image media type, network-connected storage site account balance, or a photo-image uplink priority scheme.

In a different aspect, Step 408 manages a photo-image using rules such as photo-image media type, meta-data information, acquisition limits, current storage-in-transmit memory status, permitted photo-capable devices, storage-in-transmit memory allocation dedicated to a particular photo-capable device, storage-in-transmit memory allocation dedicated to an uplink network-connected storage site, photo-image storage-in-transmit memory preservation time, folder designation, or photo-image discovery device power level.

In one aspect, managing the photo-image using meta-data information includes using criteria such as content label, location, time, and photo-image format. In another aspect, managing photo-image acquisition limits includes limiting the acquisition of photo-images in response to the storage-in-transmit memory allocation. Further, managing photo-image acquisition limits may include acquiring photo-images at a rate response to uplink storage capacity and uplink storage site bandwidth.

In a different aspect, managing the acquired photo-images based upon classification (Step 408) includes distributing photo-images in a storage-in-transit memory structure consisting of a local media memory, a removable media memory, or a combination of local and removable media memories.

In one example, Step 402 accepts a removable media memory with photo-images organized in a standard digital image exchange file structure, as defined by JEITA CP-3461. Then, distributing photo-images in a storage-in-transit memory structure includes substeps. Step 408a creates a transparent overlay file structure in the removable media memory, in parallel with the standard digital image exchange file structure, which is invisible to a photo-capable device. Step 406b incorporates the removable media memory into the photo-image discovery device storage-in-transmit memory.

Furthering the example, Step 402 may accept photo-images in a first sub-directory of the standard digital image exchange file structure associated with a first, photo-capable device protocol. Then, incorporating the removable media memory into the photo-image discovery device storage-in-transmit memory (Step 406b) includes storing photo-images in the removable media memory in a second sub-directory of the standard digital image exchange file structure associated with a second photo-capable device protocol.

A system and method have been provided for managing a photo-image discovery device database. Examples of specific processes and hardware modules have been given to illustrate the invention. However, the invention is not limited to merely these examples. Other variations and embodiments of the invention will occur to those skilled in the art.

We claim:

1. In a system using a microprocessor executing software instructions stored in a computer-readable medium, a method for managing a database in a photo-image discovery device, the method comprising:
a photo-image discovery device acquiring photo-images from a photo-capable device;
automatically classifying the acquired, photo-images, without user intervention, in a database management directory; and,
managing the acquired photo-images in a photo-image discovery device storage-in-transit memory-using database management directory rules cross-referenced to classification.

2. The method of claim 1 wherein managing the acquired photo-images in the storage-in-transit memory includes automatically uplinking photo-images to a network-connected site in response to their classification.

3. The method of claim 1 wherein automatically classifying acquired photo-images includes classifying photo-images based upon photo-image source information selected from a group consisting of a photo-capable device type, photo-capable device ID, image creation date, image creation location, and file format.

4. The method of claim 3 wherein managing the acquired photo-images based upon classification includes uplinking the photo-images in response to a condition selected from a group consisting of current uplink conditions, available uplinks, current network-connected storage site conditions, network-connected storage site processing time backlog, network-connected storage site processing cost changes, network-connected storage site memory capacity, network-connected storage site memory capacity changes, uplink bandwidth, photo-image media, type, network-connected storage site account balance, and a photo-image uplink priority scheme.

5. The method of claim 3 wherein managing the acquired photo-images based upon classification includes managing a photo-image using rules selected from a group consisting of photo-image media type, meta-data information, acquisition limits, current storage-in-transmit memory status, permitted photo-capable devices, storage-in-transmit memory allocation dedicated to a particular photo-capable device, storage-in-transmit memory allocation dedicated to an uplink network-connected storage site, photo-image storage-in-transmit memory preservation time, folder designation, and photo-image discovery device power level.

6. The method of claim 5 wherein managing the photo-image using meta-data information includes using criteria selected from a group consisting of content label, location, time, and photo-image format.

7. The method of claim 5 wherein managing photo-image acquisition limits includes limiting the acquisition of photo-images in response to the storage-in-transmit memory allocation.

8. The method of claim 5 wherein managing photo-image acquisition limits includes acquiring photo-images at a rate responsive to uplink storage capacity and uplink storage site bandwidth.

9. The method of claim 1 wherein managing the acquired photo-images based upon classification includes distributing photo-images in a storage-in-transit memory structure consisting of a local media memory, a removable media memory, and a combination of local and removable media memories.

10. The method of claim 9 wherein acquiring photo-images from the photo-capable device includes accepting a removable media memory with photo-images organized in a standard digital image exchange file structure, as defined by JEITA CP-3461;
wherein distributing photo-images in a storage-in-transit memory structure includes:
creating a transparent overlay file structure in the removable media memory, in parallel with the standard digital image exchange file structure, which is invisible to a photo-capable device; and,
incorporating the removable media memory into the photo-image discovery device storage-in-transmit memory.

11. The method of claim 10 wherein accepting the removable media memory with photo-images organized in the standard digital image exchange file structure includes accepting photo-images in a first sub-directory of the standard digital image exchange file structure associated with a first photo-capable device protocol; and,
wherein incorporating the removable media memory into the photo-image discovery device storage-in-transmit memory includes storing photo-images in the removable media memory in a second sub-directory of the standard digital image exchange file structure associated with a second photo-cap able device protocol.

12. A system including a microprocessor executing software instructions stored, in a computer-readable medium for managing a database in a photo-image discovery device, the system comprising:
a processor;
a discovery module software application having an acquisition interface for acquiring images for photo-capable devices;
a storage-in-transit memory for storing acquired photo images; and,
a database control application for automatically classifying acquired, photo-images in the storage-in-transmit memory using database management directory rules cross-referenced to classification.

13. The system of claim 12 wherein the database control application classifies photo-images based upon photo-image source information selected from a group consisting of a photo-capable device type, photo-capable device ID, image creation date, image creation location, and file format.

14. The system of claim 12 further comprising:
a network module having a network interface, for uploading photo-images to a network-connected storage site; and,
wherein the database control application automatically uplinks photo-images to a network-connected site in response to their classification.

15. The system of claim 14 wherein the database control application uplinks the photo-images in response to a condition selected from a group consisting of current uplink conditions, available uplinks, current network-connected storage site conditions, network-connected storage site processing time backlog, network-connected storage site processing cost changes, network-connected storage site memory capacity, network-connected storage site memory capacity changes, uplink bandwidth, photo-image media type, network-connected storage site account balance, and a photo-image uplink priority scheme.

16. The system of claim 15 wherein the database control application manages a photo-image using rules selected from a group consisting of photo-image media type, meta-data information, acquisition limits, current storage-in-transmit memory status, permitted photo-capable devices, storage-in-transmit memory allocation dedicated to a particular photo-capable device, storage-in-transmit memory allocation dedicated to an uplink network-connected storage site, photo-image storage-in-transmit memory preservation time, folder designation, and photo-image discovery device power level.

17. The system of claim 16 wherein the database control application manages the photo-image using meta-data information through the use of criteria selected from a group consisting of content label, location, time, and photo-image format.

18. The system of claim 16 wherein the database control application limits the acquisition of photo-images in response to the storage-in-transmit memory allocation.

19. The system of claim 16 wherein the database control application acquires photo-images at a rate responsive to uplink storage capacity and uplink storage site bandwidth.

20. The system of claim 12 further comprising:
a local media memory;
a removable media memory connected to the discovery module acquisition interface; and,
wherein the database control application distributes photo-images in a storage-in-transit memory structure consisting of the local media memory, the removable media memory, and a combination of local and removable media memories.

21. The system of claim 20 wherein the discovery module accepts a removable media memory with photo-images organized in a standard digital image exchange file structure, as defined by JEITA CP-3461;
wherein the database control module distributes photo-images in a storage-in-transit memory structure by;
creating a transparent overlay file structure in the removable media memory, in parallel with the standard digital image exchange file structure, which is invisible to a photo-capable device; and,
incorporating the removable media memory into the photo-image discovery device storage-in-transmit memory.

22. The system of claim 21 wherein the discovery module accepts photo-images in a first sub-directory of the standard digital image exchange file structure associated with a first photo-capable device protocol; and,
wherein the database control application stores photo-images in the removable media memory in a second sub-directory of the standard digital image exchange file structure associated with a second photo-capable device protocol.
